(19) United States
(12) Patent Application Publication
(10) Pub. No.: US 2023/0107844 A1
(43) Pub. Date: Apr. 6, 2023

(54) MAGNETOHYDRODYNAMIC HELICITY AND LAMINAR FLOW KINEMATIC DYNAMO GENERATORS

(71) Applicant: Daniel Prater, Noblesville, IN (US)

(72) Inventor: Daniel Prater, Noblesville, IN (US)

(21) Appl. No.: 17/960,662

(22) Filed: Oct. 5, 2022

Related U.S. Application Data
(60) Provisional application No. 63/252,581, filed on Oct. 5, 2021.

(51) Int. Cl. H02K 44/10; H02K 44/08; H02K 44/12

(52) U.S. Cl. CPC H02K 44/10; H02K 44/085; H02K 44/12

(57) ABSTRACT

Described are toroidal devices to produce steady state, helical, Taylor-Couette-like magnetohydrodynamic singular structure flows in plasma or other conductive fluids with full magnetohydrodynamic helicity. Linking of two or more such toroidal devices can be used to generate a laminar kinematic dynamo. Only one is required to confine plasma at the pressures and for times required to produce nuclear fusion. Such high-temperature plasma can also be used for centrifugal ionic separation, nuclear transmutations at production quantity, and in the near term as a study tool in the development of materials to withstand high temperature and neutron flux. Plasma is a high-energy state of matter capable of relativistic velocity en masse, and as such, relativistic plasma or other conductive fluid devices are a means to generate gravity.

### CROSS-REFERENCE TO RELATED APPLICATIONS

This U.S. non-provisional patent application claims the benefit of and/or the priority under 35 USC § 119(e) to U.S. provisional application Ser. No. 63/252,581 filed Oct. 5, 2021 titled “Magnetohydrodynamic Boat Motor, Pump, and Sensor, and Helicity Generator (Dynamo),” the entire contents of which is specifically incorporated herein by reference.

### FIELD OF THE INVENTION

The present invention is related to devices that produce motion in conductive fluids including devices and methods for ionized gas (plasma) confinement and devices and methods for nuclear fusion. The invention further relates to devices and methods to generate a magnetic field from the flow of a conducting fluid, i.e., devices that exhibit dynamo behavior.

### BACKGROUND OF THE INVENTION

A key effort in plasma physics is the search for new device configurations capable of generating certain plasma configurations. One device configuration being sought generates a certain minimum plasma pressure for a time sufficient for sustained thermonuclear fusion [1]. Another produces the dynamo effect [2].

Central to both dynamo behavior and fusion is the conserved quantity of helicity in its magnetic [3], hydrodynamic [4], and cross forms [5]. Magnetic helicity can be generated in plasma when current is driven along a magnetic field line [3]. The electric field can be transformed away in a moving frame of reference [6] so particles experience no magnetic helicity in the reference frame of steady flow. Here I describe a device able to generate full magnetohydrodynamic (MHD) helicity.

Cowling's theorem dictates that dynamo behavior requires asymmetry [7]. Spatial periodicity, i.e., B(x+lᵢ)=B(x) where B is the magnetic field, satisfies this asymmetry requirement [8] [9]. Examples of spatial B-field periodicity are readily apparent in cusped magnetic field configurations as the fields alternate in polarity along a length [10]. In addition, Komarov et al. showed that spatially periodic fields satisfy the Boltzmann equation for plasmas in steady state and observed spatial periodicity in pinch experiment plasmas [11] [12].

Driving currents across cusped magnetic fields can produce Taylor-Couette flows in plasmas or other conductive fluids [13] [14]. Current provides torque at the fluid edge and the velocity of the resulting flow is given by E×B/B² where E is the electric field. Azimuthal flows in cylindrical and spherical geometry plasmas have been driven by spatially periodic polar (poloidal) currents across spatially periodic polar magnetic cusps. The Big Red Ball device at University of Wisconsin-Madison has 36 rings of permanent magnets fastened to the wall of a spherical chamber to create 36 magnetic cusps for lᵢ=π/18 periodicity along the π radians of its polar angle [15]. These currents impart azimuthal Lorentz J×B torque at the plasma edge. Momentum flows from the fields by Poynting's theorem. It does not appear that extension of the above single-direction flow to two-directional flow has been reported or disclosed by anyone.

In view of the above, it would be beneficial to have a device or devices and methods to combine toroidal flow with poloidal flow for helical fluid flow in conductive fluids with helical magnetization, and give some uses for such configurations of matter. The present invention provides this.

### SUMMARY OF THE INVENTION

The present invention provides means for laminar fluid kinematic dynamo embodiments from embodiments of at least one magnetohydrodynamic (MHD) helicity generator. The means for constructing a magnetohydrodynamic generator are disclosed herein. A laminar fluid kinematic dynamo can be constructed by linking or interlocking two toroidal magnetohydrodynamic generators or to construct a single magnetohydrodynamic helicity generator with write, twist, or crossing topologies. These topologies are provided and a linkage topology is shown herein as a representative embodiment. Additional means are provided for reducing the number of magnetic field coils and electrodes necessary for inducing flow in the conductive fluid.

Further aspects of the present invention will become apparent from consideration of the drawings and the following description of forms of the invention. A person skilled in the art will realize that other forms of the invention are possible and that the details of the invention can be modified in a number of respects without departing from the inventive concept. The following drawings and description are to be regarded as illustrative in nature and not restrictive.

### DESCRIPTION OF THE DRAWINGS

The present invention and its features will be better understood by reference to the accompanying drawings, wherein:

FIG. 1 shows one embodiment of a single MHD helicity generator 10 with toroidal field coils TFC, poloidal field electrodes PFC, toroidal field electrodes TFE, poloidal field electrodes PFE, and vacuum chamber VC. In other embodiments of the device, for example if the device is used for fusion with direct conversion [16], the device may be thermodynamically open with the vacuum chamber being far outside the field coils. The device shown here has an aspect ratio of about 2.5. Practical devices benefit from having a high aspect ratio. For fusion an aspect ratio of 16 may be ideal [29] and may simplify construction with linked, writhed, twisted, or crossed topologies. Components required to produce the fields, currents, vacuum, etc. are well known to those skilled in the art and are not shown for clarity. In no figures are magnetic helicity injectors shown as these are well known to those skilled in the art and would unnecessarily crowd the figures.

FIG. 2 shows a toroidal cutaway view of the single MHD helicity generator 10 of FIG. 1 taken along line 2-2 of FIG. 1 showing representative portions of simplified circuits for toroidal flow TF and poloidal flow PF.

FIG. 3 shows another toroidal cutaway view of the single MHD helicity generator 10 of FIG. 1 showing spatially periodic poloidal cusped magnetic fields B (solid lines) with intersecting electric fields E (dashed lines) and a single simplified toroidal flow circuit to drive spatially periodic currents J across the cusped poloidal magnetic fields to produce J×B torque at the plasma edge to drive toroidal fluid flow St, here into the page ⊗. Poloidal plasma fluid flow Sp is also shown. Inner small squares deep to the magnetic field lines represent poloidal field coils encircling the device axis (left-most solid line). Inset 14 shows a perspective view of the generator 10 with a similar toroidal cutaway showing both toroidal inner and outer poloidal field coils. Poloidal and toroidal coil order in depth can be switched. Vacuum chamber, toroidal field coils, fields, and electrodes not shown for clarity.

FIG. 4 shows a top-down mid-plane poloidal cut-away of the single MHD helicity generator 10 of FIG. 1 showing toroidal magnetic cusp fields B with poloidal flow Sp circulating into and out of the page driven by toroidal field electrodes TFE connected to a simple circuit. Toroidal flow St is shown for comparison. Not shown for clarity are toroidal electric fields lines across the toroidal magnetic field lines, and all poloidal components. Inset 16 shows a 3-dimensional perspective view with a similar top-down midplane poloidal cut-away.

FIG. 5 shows a perspective view of MHD helicity generator embodiment 10a with toroidal housing 12a where the poloidal and toroidal conductors of MHD helicity generator 10 are supplanted by two helical coils HC A and HC B instead of separate poloidal and toroidal external coil windings. Here the external conductors producing the cusped magnetic fields are interlaced or woven in such a way as to produce the necessary poloidal and toroidal spatial periodicity. Field linkage, writhe, twist, and crossing may be formed by appropriate external conductor winding and vacuum chamber shaping like for a stellarator with the obvious modification of cusped fields rather than the aligned fields of the stellarator. Here the helical coil windings produce helical magnetic fields and the poloidal and toroidal electrodes to drive current has been supplanted by a single set of helical electrodes HCE positioned appropriately to drive current across the helical magnetic field. As before, each electrode polarity is opposed to its neighboring electrodes (circuit not shown for clarity).

FIG. 6 shows a single dynamo unit 50 composed of two (dual) MHD helicity generators A and B such as those shown in FIGS. 1-5.

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the described embodiments, and any further applications of the principles of the invention as described herein are contemplated as would normally occur to one skilled in the art to which the invention relates.

### DESCRIPTION OF THE INVENTION

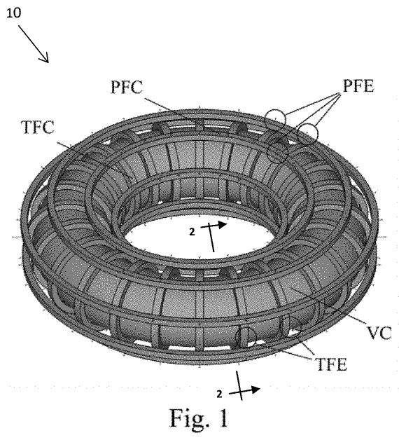

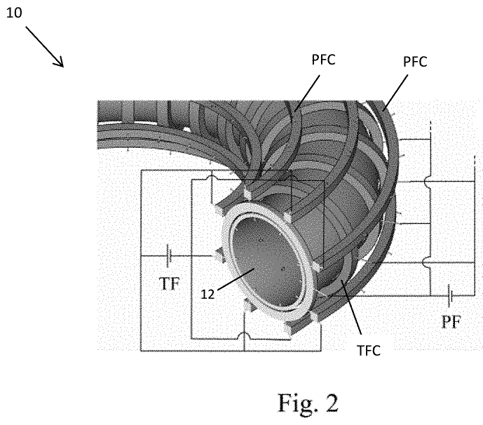

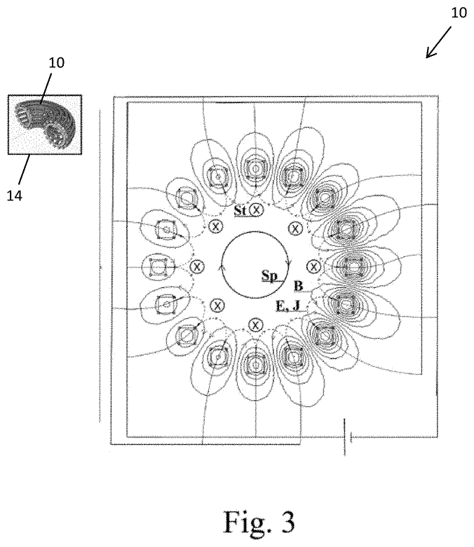

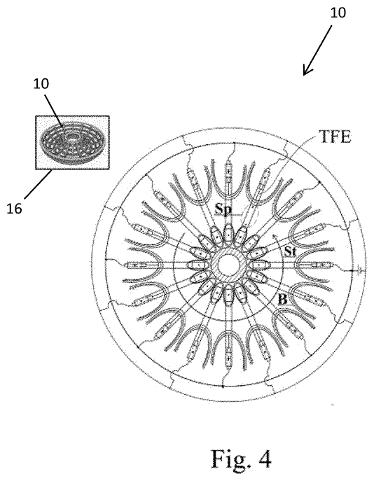

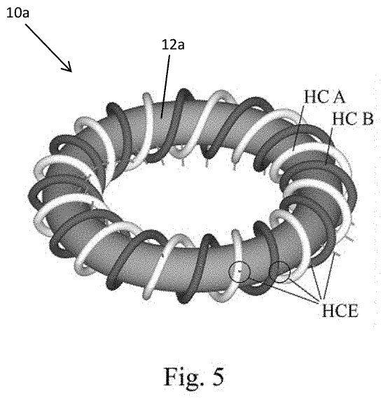

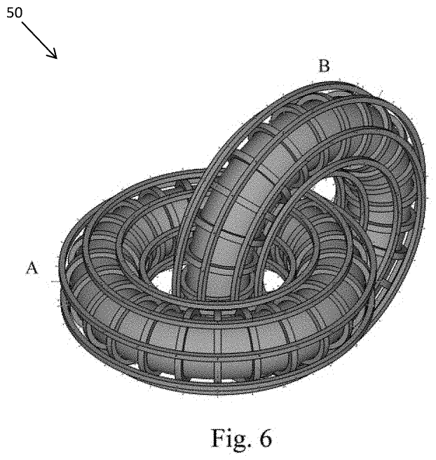

FIGS. 1-4 show an exemplary magnetohydrodynamic (MHD) helicity generator 10 with a Vacuum Chamber VC fashioned as a toroidal housing 12. FIG. 5 shows another exemplary MHD helicity generator 10a. FIG. 6 shows an exemplary single dynamo unit 50 composed of two MHD helicity generators A and B such as that shown in FIGS. 1-5. In each MHD helicity generator each magnetic field coil in a given directional arc (toroidal or poloidal) carries current opposed in direction to its neighboring coil to generate magnetic cusps as is well known to those skilled in the art. Electrodes also oppose in polarity along each arc carrying current to impart J×B torque in a direction orthogonal to both magnetic and electric field. As spatially periodic polar (poloidal) currents across spatially periodic polar (poloidal) magnetic cusps drives azimuthal (toroidal) plasma fluid flow, in swapping coordinates from poloidal to toroidal, spatially periodic toroidal currents across spatially periodic toroidal magnetic cusps drives poloidal fluid flow. Toroidal magnetic and electric field components together drive poloidal flow and poloidal field components together drive toroidal flow. The interlocked combination of toroidal and poloidal flows provides for hydrodynamic helicity similar to the way toroidal and poloidal fields interlock to produce magnetic helicity.

Producing both toroidal and poloidal flows forms a hydrodynamic singular structure by conservation of hydrodynamic helicity [4]. Conservation of helicity maintains flux linkage. Analogous to the way smoke and bubble ring hydrodynamic vorticity conservation conserves flux linkage, poloidal flow conserves poloidal particle flux linkage as toroidal circulation conserves toroidal particle flux linkage. In the practice of plasma confinement, particles lost out any one cusp loss region (poloidal or toroidal) would necessarily reduce flux linkage, so in the absence of transient disruptive effects plasma is confined.

Magnetic helicity in a fluid with helical flow produces a magnetic singular structure possessing canonical MEM helicity. A number of means of magnetic helicity injection have been developed including coaxial [17] and steady-inductive imposed-dynamo current drive [18]. Added heating can employ any of the conventional wave or particle means [19]. A 3-dimensional view of one embodiment MHD helicity generator is shown in FIG. 1.

Beginning in the 1960's, adequate starting singular structure plasma rings, plasmoids, or spheromaks, the configuration sought in the Tormac, were produced in experiments [20]. In the 1970's hot electrons (Tₑ>Tᵢ) enabled separatrix formation about the magnetic axis to separate passing and confined plasma in multipole cusped-field toroidal plasma configurations [21] [20] [22].

Two ways of visualizing a single MHD helicity generator may be instructive. The cylindrical Plasma Couette eXperiment, predecessor to the spherical Big Red Ball, produces azimuthal (toroidal) flow by driving currents across magnetic fields spatially periodic along the polar (poloidal) z-axis [23]. If the axis is extended and the ends linked into a torus the device is now driving poloidal flow by the change in coordinate. To generate helical flow, to the now toroidal device with toroidal field periodicity and poloidal flow, periodic poloidal magnetic cusps and currents can be added to drive toroidal flow. The PCX device has an additional central column of fields and currents but we ignore these in this example. The spherical Big Red Ball device does not have this central column.

Alternatively, the MHD helicity generator looks somewhat similar to a magnetic helicity-injected Tokamak fusion reactor, but all the magnetic fields are cusped, and across the magnetic fields, currents drive flow. In the Tokamak the toroidal and poloidal magnetic fields are aligned, the device must withstand compressive stress, and the plasma is subject to interchange down the field gradient. The Tokamak design does not have means to drive flow aside from external drives such as neutral beam injection despite flow being crucial for transition to the high-confinement H-mode of operation. In the tokamak, the magnetic field is bent into a torus and this is well known to be unstable. In the device proposed here the cusped fields produce an expansive force on the reactor and there is no interchange risk. Here, a steady-state singular structure plasmoid is spun up and confined to a static minimum-B well, and this is well known to be stable [24] [25] [26], in the very least, when the flow velocity is driven at the Alfvén velocity [27].

In another embodiment of the invention the device may be constructed of coils that wind both ways around the toroidal device to produce the necessary poloidal and toroidal spatial field periodicity across which currents can be driven to drive flow. FIG. 5 shows one such representative embodiment 10a. The advantage of such a configuration may be the use of fewer materials but disadvantages may be in complexity in fabrication or inflexibility in parameters such as safety factor. Instead of separate and orthogonal poloidal and toroidal external coil windings, two helical coils HC A and HC B are wound about the vacuum chamber housing 12a. Here the external conductors producing the cusped magnetic fields are interlaced or woven in such a way as to produce the necessary poloidal and toroidal field component spatial periodicity. Field linkage, writhe, twist, and crossing may be formed by appropriate external conductor winding and vacuum chamber shaping like for a stellarator with the obvious modification of electrodes and cusped fields rather than the aligned fields of the stellarator.

Dynamo behavior, or the production of a steady magnetic field by the flow of a conductive fluid, is expected when laminar vortex rotor flows of conducting fluids with meridional (poloidal) circulation are combined with “sufficient vigour and complexity” [28]. We claim here that such vigor can be combinations of the above magnetic laminar flows in an interlocking geometry as shown in the FIG. 6 which shows a single dynamo 50 composed of two MHD helicity generators A and B such as that shown in FIGS. 1-5. The configuration may have sufficient writhe, twist, or crossing [3] and that such flow combinations may help explain solar and planetary magnetic fields by subsurface currents across magnetic fields [28].

Gravity is created by sufficiently increasing the electric and magnetic forces in one or a combination of the above reactor systems to engage a measurable change in Maxwellian stress-energy tensor by the Thirring-Lense effect of rapidly rotating bodies [30].

While the invention has been illustrated and described in what is presently considered to be the most practical and preferred embodiment, it is to be understood that the invention is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Accordingly, the scope of the present invention should be considered in terms of the following claims and is understood not to be limited to the details of structure and operation shown and described in the specification and drawings.

It should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Unless specifically stated to the contrary in the claim, the language “at least one of X, Y, and Z” should be interpreted as including both the conjunctive and disjunctive forms. Specifically, the language “at least one of X, Y, and Z” is intended to encompass the following permutations of X, Y, and Z: X alone; Y alone; Z alone; X and Y; X and Z; Y and Z; and X, Y, and Z. Further, when the language “at least a portion” and/or “a portion” is used the item may include a portion and/or the entire item unless specifically stated to the contrary.
[1] National Academies of Sciences, Engineering, and Medicine, Final Report of the Committee on a Strategic Plan for U.S. Burning Plasma Research, 2019.
[2] D. P. Lathrop and C. B. Forest, Magnetic Dynamos in the Lab, Phys. Today 64, 40 (2011).
[3] M. Bellan Paul, Magnetic Helicity, Spheromaks, Solar Corona Loops, And Astrophysical Jets (World Scientific, 2018).
[4] H. K. Moffatt, Helicity and Singular Structures in Fluid Dynamics, Proc. Natl. Acad. Sci. 111, 3663 (2014).
[5] G. Webb, Helicity in Fluids and MHD, in Magnetohydrodynamics and Fluid Dynamics: Action Principles and Conservation Laws, edited by G. Webb (Springer International Publishing, Cham, 2018), pp. 21-36.
[6] J. D. Jackson, Classical Electrodynamics, 3rd Ed., Am. J. Phys. 67, 841 (1999).
[7] T. G. Cowling, Magnetohydrodynamics (Interscience Publishers, 1957).
[8] G. O. Roberts, Spatially Periodic Dynamos, Philos. Trans. R. Soc. Lond. Ser. Math. Phys. Sci. 266, 535 (1970).
[9] G. O. Roberts, Dynamo Action of Fluid Motions with Two-Dimensional Periodicity, Philos. Trans. R. Soc. Lond. Ser. Math. Phys. Sci. 271, 411 (1972).
[10] T. J. Dolan, Magnetic Electrostatic Plasma Confinement, Plasma Phys. Control. Fusion 36, 1539 (1994).
[11] N. N. Komarov, Topology of Steady-State Plasma Configurations in Transverse Self-Consistent Fields: Spatial-Periodic Plasma Structures: I, Nucl. Fusion 3, 174 (1963).
[12] N. N. Komarov, I. F. Kvartskhava, and V. M. Fadeev, Topology of Steady-State Plasma Configurations in Transverse Self-Consistent Fields: Spatial-Periodic Structures: II., Nucl. Fusion 5, 192 (1965).
[13] E. J. Spence, K. Reuter, and C. B. Forest, A Spherical Plasma Dynamo Experiment, Astrophys. J. 700, 470 (2009).
[14] C. Collins, M. Clark, C. Cooper, K. Flanagan, I. Khalzov, M. Nornberg, B. Seidlitz, J. Wallace, and C. Forest, Taylor-Couette Flow of Unmagnetized Plasma, Phys. Plasmas 21, 042117 (2014).
[15] C. M. Cooper et al., The Madison Plasma Dynamo Experiment: A Facility for Studying Laboratory Plasma Astrophysics, Phys. Plasmas 21, 013505 (2014).
[16] G. H. Miley and U. S. E. R. and D. A. D. of T. Information, Fusion Energy Conversion (American Nuclear Society, 1976).
[17] R. Raman, T. Brown, L. A. El-Guebaly, T. R. Jarboe, B. A. Nelson, and J. E. Menard, Design Description for a Coaxial Helicity Injection Plasma Start-Up System for a ST-FNSF, Fusion Sci. Technol. 68, 674 (2015).
[18] T. Jarboe, B. Victor, B. Nelson, C. Hansen, C. Akcay, D. Ennis, N. Hicks, A. Hossack, G. Marklin, and R. Smith, Imposed-Dynamo Current Drive, Nucl. Fusion 52, 083017 (2012).
[19] R. A. Cairns, Radiofrequency Heating of Plasmas, 1st ed. (CRC Press, Bristol, England; Philadelphia, 1991).
[20] C. W. Hartman, Formation of Toroidal Plasma Confinement Configurations by Using Hot Electrons, No. UCID-18239, California Univ., 1979.
[21] C. W. Hartman, Toroidal Stabilized Pinch Formed with Relativistic Electrons, Phys. Rev. Lett. 26, 826 (1971).
[22] M. A. Levine, Use of a Hot Sheath Tormac for Advance Fuels, (1977).
[23] C. Collins, N. Katz, J. Wallace, J. Jara-Almonte, I. Reese, E. Zweibel, and C. B. Forest, Stirring Unmagnetized Plasma, Phys. Rev. Lett. 108, 115001 (2012).
[24] R. N. Sudan, Stability of Field-Reversed, Force-Free, Plasma Equilibria with Mass Flow, Phys. Rev. Lett. 42, 1277 (1979).
[25] K. C. Tsinganos, Magnetohydrodynamic Equilibrium. III—Helically Symmetric Fields. IV—Nonequilibrium of Nonsymmetric Hydrodynamic Topologies, Astrophys. J. 259, 820 (1982).
[26] E. Hameiri, The Equilibrium and Stability of Rotating Plasmas, Phys. Fluids 26, 230 (1983).
[27] S. Chandrasekhar, ON THE STABILITY OF THE SIMPLEST SOLUTION OF THE EQUATIONS OF HYDROMAGNETICS, Proc. Natl. Acad. Sci. U. S. A. 42, 273 (1956).
[28] K. Moffatt and E. Dormy, Self-Exciting Fluid Dynamos (Cambridge University Press, Cambridge, 2019).
[29] A. B. Hassam and Y.-M. Huang, Thermoelectric Rotating Torus for Fusion, Phys. Rev. Lett. 91, 195002 (2003).
[30] B. Mashhoon, F. W. Hehl, and D. S. Theiss, On the Gravitational Effects of Rotating Masses: The Thirring-Lense Papers, Gen. Relativ. Gravit. 16, 711 (1984).

What is claimed is:

1. A dynamo generator.

2. The dynamo generator of claim 1 formed of at least two magnetohydrodynamic helicity generators.

3. The magnetohydrodynamic helicity generator of claim 2 comprising an internal working fluid.

4. The magnetohydrodynamic helicity generator of claim 2 being a toroidal device.

5. The magnetohydrodynamic helicity generator of claim 2 having cusped magnetic fields at the edge of the internal working fluid driven by currents external to the internal working fluid.

6. The magnetohydrodynamic helicity generator of claim 3 wherein the internal working fluid comprises an ionized gas (plasma) or other conductive fluid such as seawater, liquid metal, liquid salt or other suitable conductive fluid.

7. The magnetohydrodynamic generator of claim 2 comprising electrodes disposed at the edge of the internal working fluid to provide currents across the cusped magnetic fields to provide torque upon the internal working fluid.

8. The magnetohydrodynamic generator of claim 7 wherein the electrodes are opposing in polarity around the poloidal and/or toroidal arc of the magnetohydrodynamic helicity generator.

9. The dynamo generator of claim 1 being formed of at least two interlocking magnetohydrodynamic helicity generators.

10. The dynamo generator of claim 1 being formed of a single toroidal magnetohydrodynamic generator with topological writhe, twist, or connection.

11. The magnetohydrodynamic helicity generator of claim 2 having at least one of the means for magnetic helicity injection into the internal working fluid.

12. The magnetohydrodynamic generator of claim 2 having magnetic and electric fields with spatially periodic poloidal and toroidal components.

13. The magnetohydrodynamic generator of claim 12 wherein the periodicity is being provided by separate toroidal and poloidal field coils and electrodes.

14. The magnetohydrodynamic generator of claim 12 wherein the periodicity is being provided by winding at least two coils in a helical manner around the poloidal and toroidal directions of the magnetohydrodynamic generator to create the spatially periodic magnetic field and an array of electrodes suitably positioned to provide currents across the spatially periodic magnetic fields.
